(19) United States
(12) Patent Application Publication
(10) Pub. No.: US 2008/0238081 A1
(43) Pub. Date: Oct. 2, 2008

(54) Laptop book holder

(75) Inventor: Gloria Joy Souders, Pleasant Hill, CA (US)

Correspondence Address: GLORIA SOUDERS, 475 MALAGA WAY, PLEASANT HILL, CA, 94523, US

(73) Assignee: GLORIA JOY SOUDERS, PLEASANT HILL, CA (US)

(21) Appl. No.: 11/728,708

(22) Filed: Mar. 27, 2007

(51) Int. Cl. B42D 17/00

(52) U.S. Cl. 281/45

(57) ABSTRACT

This invention is a solid piece of polyurethane foam that is 11″ wide, 9″ deep at the base, and 8″ high at the back. The shape as seen from the side resembles a comma rotated so that the tail is the base. The back portion upon which the book or magazine rests is at a 45 degree angle to the base. The front shelf in front of the book holder is 3″ high and extends 5½″ from the book holder. The weight of the book on the shelf assists in holding the device stable wherever placed. The polyurethane foam is covered with fabric that can have any kind of design or color on it. A flexible fabric bookmark of the same fabric is attached to the top of the back of the invention in the center. It extends 12½″ to its weighted end and is 1″ wide.

### CROSS REFERENCE TO RELATED APPLICATIONS

Not applicable.

### STATEMENT OF FEDERALLY SPONSORED RESEARCH/DEVELOPMENT

Not applicable.

### REFERENCE TO A “SEQUENCE LISTING”

Not applicable.

### BACKGROUND OF THE INVENTION

It is difficult for people to read a book (or magazine) while in a chair or bed, or in the case of children on the floor, because it is difficult to keep the book propped up and in the proper position, as well as keep the book from closing or the pages from unwanted turning, thus discouraging reading. This invention is a portable book holder that can be placed on one's lap, on the floor, or any flat surface. It keeps the book upright and at the proper reading angle, and includes a built-in bookmark and page keeper. In addition, it has a built-in shelf in front of where the book is placed so that the reader can rest his or hands on it (which is useful when following the words with one's finger), or reading glasses, or even a coffee cup without fear of the device tilting or tipping over. The weight of the book on the shelf assists in holding the device stable wherever placed. Taken together these attributes would tend to encourage people to read.

### BRIEF SUMMARY OF THE INVENTION

This invention is a solid piece of polyurethane foam that is 11″ wide, 9″ deep at the base, and 8″ high at the back. The shape as seen from the side resembles a comma rotated so that the tail is the base. The back portion upon which the book or magazine rests is at a 45 degree angle to the base. The front shelf in front of the book holder is 3″ high and extends 5½″ from the book holder. The polyurethane foam is covered with fabric that can have any kind of design or color on it. A flexible fabric bookmark of the same fabric is attached to the top of the back of the invention in the center. It extends 12½″ to its weighted end and is 1″ wide.

### BRIEF DESCRIPTION OF THE SEVERAL VIEWS OF THE DRAWING

FIG. 1—View of the top and left side of the invention. Reference numeral 1 indicates the fabric covered polyurethane portion of the invention. Reference numeral 2 indicates a typical open book placed in the invention for reading. Reference numeral 3 indicates the flexible, weighted fabric bookmark.

FIG. 2—View of the top and right side of the invention showing the underlying polyurethane and the weight inside the end of the bookmark. Reference numeral 4 indicates the polyurethane underlying the covering fabric. Reference numeral 5 indicates the weight sewed into the end of the flexible, fabric bookmark.

FIG. 3—View of the right side of the invention, with the weighted bookmark draped over the front.

FIG. 4—View of the front of the invention showing the angled front of the shelf base and the bookmark.

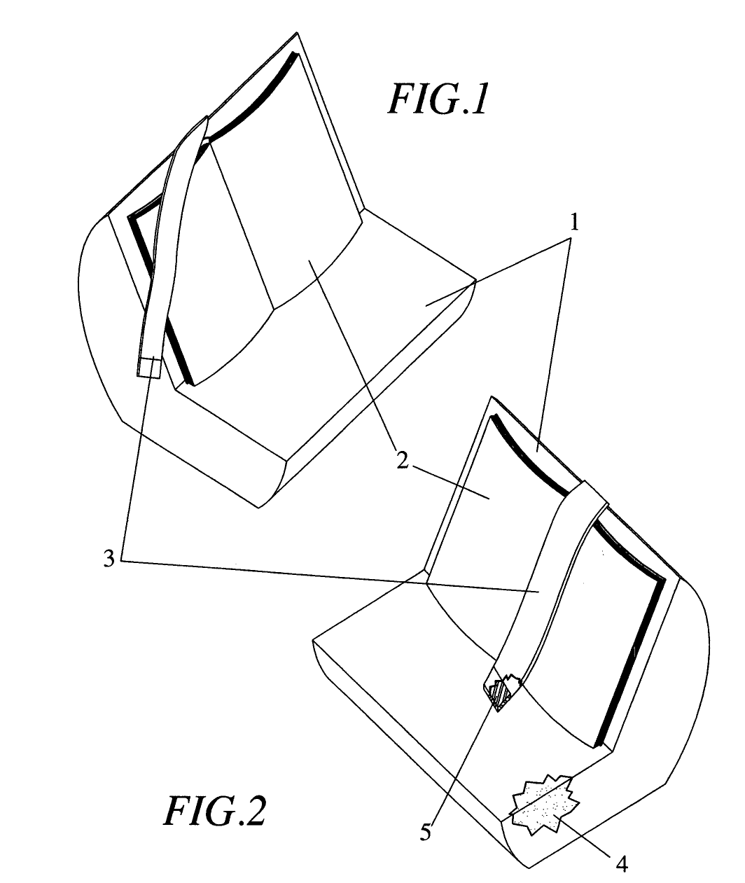

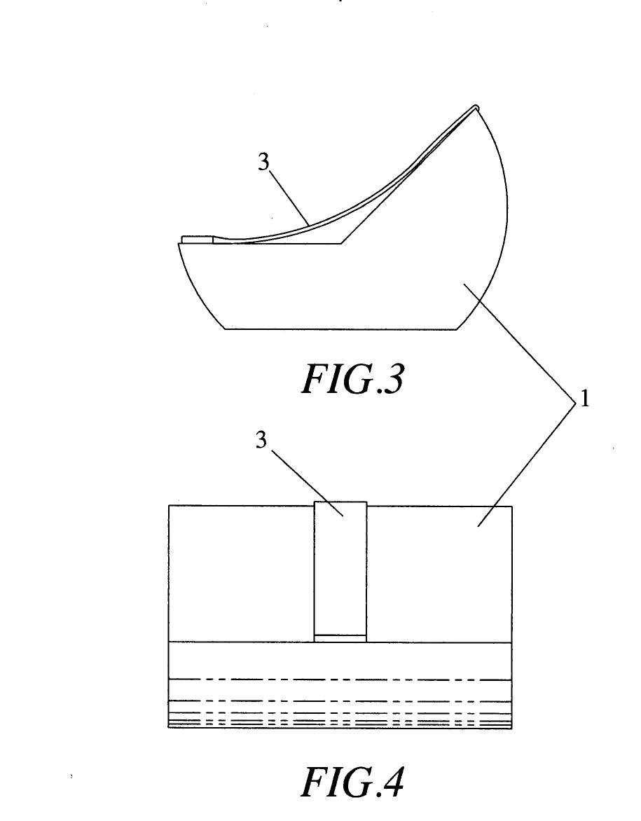

### DETAILED DESCRIPTION OF THE INVENTION

This invention is a solid piece of polyurethane foam that is 11″ wide, 9″ deep at the base, and 8″ high at the back. These dimensions could be increased for very large adults or decreased for very small children. Because it is made of light material, it can be placed on one's lap without causing fatigue. The shape as seen from the side resembles a comma rotated so that the tail is the base. The shape is rounded and angled so as to conserve material and contribute to keeping the invention light in weight. The back portion upon which the book or magazine rests is at a 45 degree angle to the base. The front shelf in front of the book holder is 3″ high and extends 5½″ from the book holder. The shelf is wide enough so that the reader can rest his or her hands on it (which is useful when following the words with one's finger), or reading glasses, or even a coffee cup without fear of the device tilting or tipping over. Because the invention is light, soft, and has curved edges, it will not hurt a child if it falls on him or her. The weight of the book on the shelf assists in holding the device stable wherever placed. The polyurethane foam is covered with fabric that can have any kind of design or color on it, which could include designs or drawings for children. A flexible fabric bookmark of the same fabric is attached to the top of the back of the invention in the center. It extends 12½″ to its weighted end and is 1″ wide. This enables the reader to keep the page of the book flat and in place for easy reading. In addition, the softness and flexibility makes it easy to turn to the next page and keep it in place.

1. The laptop book holder is mainly a single piece of polyurethane foam, covered with a soft fabric, in such a shape and size so as to permit it to be positioned on the lap of a reader when seated, or on a flat surface such as a table, and thus is light, unbreakable, and safe for use by children.

2. The overall design of the laptop book holder is such that the book is held in the correct position to avoid falling out and to facilitate page turning, allowing pages to lay flat and stay in place.

3. The wide front shelf helps balance the laptop book holder to prevent it from tipping over, as well as providing a flat surface for resting hands, eyeglasses, coffee cup, etc., while the weight of the book on the shelf assists in holding the device stable wherever placed.

4. The bookmark page holder on the laptop book holder is long, flexible, and weighted which helps to hold the pages down and so that the reader can't lose his place.
